(19) United States
(12) Patent Application Publication
(10) Pub. No.: US 2003/0180342 A1
(43) Pub. Date: Sep. 25, 2003

(54) Method for pest control

(76) Inventors: Liye Ju, Zibo (CN); Zhiqiang Ju, Zibo (CN); Yousheng Duan, Zibo (CN)

Correspondence Address: Zhiguo Ju, Liposcience International LLC., P.O. Box 2521, Wenatchee, WA, 98801, US

(21) Appl. No.: 10/360,130

(22) Filed: Feb. 6, 2003

Related U.S. Application Data
(60) Provisional application No. 60/360,517, filed on Feb. 28, 2002.
(60) Provisional application No. 60/366,157, filed on Mar. 21, 2002.

(51) Int. Cl. A01N 43/04; A01N 25/00; A01N 37/00; A01N 59/22

(52) U.S. Cl. 424/405; 514/558; 424/667; 514/60

(57) ABSTRACT

Method for controlling insect pests, pathogenic diseases, and pathogenic nematodes comprising the step of concurrent administration to the locus of an effective amount of iodized lipids or iodine complexes was disclosed.

### CROSS-REFERENCE TO RELATED APPLICATIONS

Part of this application claims benefit of U.S. Provisional Applications No. 60/360,517, filed on Feb. 28, 2002, entitled “lodinated compositions for pesticides and disinfectant applications' and No. 60/366,157, filed on Mar. 21, 2002, entitled “Iodine complexes for plant protection”.

### TECHNICAL FIELD

This invention relates to a method for controlling insect pests, pathogenic diseases, and parasitic nematodes by using compositions comprising iodized lipids or iodine complexes.

### STATEMENT REGARDING FEDERALLY SPONSORED RESEARCH OR DEVELOPMENT

The present invention was not federally sponsored in the United States.

### BACKGROUND OF THE INVENTION

Molecular iodine and iodine releasing compounds or complexes possess antifungal, antibacterial, and antivirus activities and are widely used as disinfectants in hospitals, dairy farms, or homes. Molecular iodine and iodine releasing compounds or complexes have also been used as pesticides to treat plants or crops. U.S. Pat. No. 608,627 to Thiele discloses a mixture of kerosene oil, turpentine oil, tinctured iodine, and sulfur for killing weevils. The mixture was applied to treat seeds, i.e., corn, bean or pea seeds, by soaking these nongerminated seeds in the mixture for three days before planting. Japanese patent No. 61-183202 A discloses the spraying of an aqueous solution consisting of 1-3% citric acid and 0.2% iodine over the surface of the leaves and stems of field crops for controlling pest damage and diseases. U.S. Pat. No. 2,742,736 to MacKay discloses an after-planting treatment of citrus trees already infested with citrus nematode by applying a diluted tincture of iodine solution to the soil surrounding such trees. And U.S. pending patent application (20010019728) disclosed the use of molecular iodine or ionic iodine complex for plant and/or crop protection against plant and/or crop pests.

While iodine-ethanol solution (tinctured iodine) or type I iodine complex (iodophors) are effective as disinfectants or pesticides, the high vapor pressure of iodine makes the product difficult to storage, transport, and use. This is especially true when these products were used as pesticides in the fields with strong light and high temperature. Even for disinfectant application on animals such as cows, these formulations often cause side effects such as teat cracks, scores, and callous. Therefore, there is a need to improve the stability of iodine formulations for both agricultural and disinfectant applications and it is an object of the present invention to develop iodine formulations with high stability and high pesticide activity.

According to the composition and formation, iodine containing compounds or complexes may be divided into four groups: molecular iodine, type I iodine complex (complexes formed through ionic or hydrogen bounds), type II iodine complex (complexes formed through physical barriers), and organic iodine (formed through covalent bounds). For disinfectant application, molecular iodine is often dissolved in ethanol (tinctured iodine) or other organic solvents. Type I iodine complex is formed either ionically or nonionically (Basinger et al, U.S. Patent application Ser. No. 20010019728). The ionic complexes comprise elemental iodine and a complexing agent, i.e., a cation or an organic group comprising an amine. The nonionic iodine complexes (iodophors) comprise elemental iodine and organic polymeric materials having large segments of polymeric residues, for example, polyvinylpyrrolidine (PVP), non-ionic, anionic, or cationic surfactants (U.S. Pat. Nos. 2,739,922; 2,931,777; 5,022,763; 5,368,868; 5,916,581). Type II iodine complex is formed between iodine and polymers through physical mechanisms, for example, iodine-starch complex, in which molecular iodine is trapped inside the helix of starch molecules. As for organic iodine, it is formed through covalent bunds. Iodized lipids are organic iodine compounds formed through iodine and the double bounds of the lipids.

Surprisingly, we found that iodized lipids and type II iodine complex display high iodine stability and high pesticide activity.

Although iodized lipids have been widely used in medical diagnoses and as food supplements, they have not been used as disinfectants or pesticides. U.S. Pat. No. 5,462,714 discloses a disinfectant composition, which includes a mixture of iodine and short chain fatty acids, which consist of formic acid, acetic acid, propionic acid, n-butyric acid, iosbutyric acid, n-valeric acid, isovaleric acid, and lactic acid. U.S. Pat. (pending) No. 20010036482 disclosed that a mixture of iodine and short chain (C6-C12, preferably C7-C9) fatty acids as antimocrobial agent in controlling mastitis, a disease caused by bacteria. These acids, however, do not contain double bounds and therefore, the mixture of these acids with iodine is different from the iodized lipids described in the present invention.

Iodine-starch complex has been well known in the literature and has been disclosed as iodine supplement in human (U.S. Pat. No. 5,955,101). The pesticide and disinfectant activity of type II iodine complex including iodine-starch complex, however, has not been disclosed before.

### BRIEF SUMMARY OF THE INVENTION

In accordance with the present invention, a method of controlling insect pests, diseases, and parasitic nematodes comprising applying to a locus an effective amount of iodized lipids or type II iodine complex is provided.

A first embodiment of the present invention is directed to compositions comprising iodized lipids formed between iodine and lipids or lipid derivatives.

A second embodiment of the present invention is directed to a method of controlling insect pests, diseases, and parasitic nematodes comprising applying to a locus an effective amount of said compositions comprising iodized lipids.

Lipids and lipid derivatives in the present invention are defined as a group of organic compounds that are soluble in organic solvents, which comprises 1) fatty acids, their salts, esters, or derivatives; 2) fatty alcohols and their derivatives; 3) mono-, di-, and tri-acylglycerides (including phospholipids, glycolipids, plant oil, animal oil or fat) and their derivatives; 4) mono-, di-, tri-, and tetra-terpenes, steroids, cholesterols, and their derivatives; and 5) waxes or esters of long chain fatty acids and long chain alcohols and their derivatives.

Still another embodiment of the present invention is directed to compositions comprising type II iodine complex or mixtures of type II iodine complexes.

Yet another embodiment of the present invention is directed to a method of controlling insect pests, diseases, and parasitic nematodes comprising applying to a locus an effective amount of said compositions comprising type II iodine complex.

‘Type II iodine complex’ in the present invention comprise any complexes formed through physical mechanisms between iodine and compound or compounds with large molecular size and structures that can trap molecular iodine. Example of such compounds are amylose, starch and amylose or starch containing materials such as amylose, amylospetcin, starch, modified starch such as acid, alkaline, or enzyme treated starch, oxidized starch, dextrin roasted starch, or esterified starch, starch containing flours from any plant sources, degradation products from flours or starch, dextrin, or their derivatives.

In all of the embodiments, a locus is defined as anything that needs said treatment, which comprises human being, animals, equipments, dairy farm, food industry facility, working or living environment, body water, insect pests, microbial pathogens, virus pathogens, nematodes, drink or irrigation water, soil, plants, crops, seeds, fruits, or any parts of any plants.

### DETAILED DESCRIPTION OF THE PREFERRED EMBODIMENT

In describing the preferred embodiment, certain terminology will be used for the sake of clarity.

As used herein, the term ‘lipids’ represents a group of organic compounds that are soluble in organic solvents, which comprises 1) fatty acids, 2) fatty alcohols, 3) terpenoids, 4) waxes, and 5) acylglycerides, or their derivatives.

As used herein, the term ‘iodized lipids’ is equivalent to ‘iodinated lipids’ and the iodized lipids are formed between iodine and lipids through covalent bound.

As used herein, the term ‘type II iodine complex’ comprises any complexes formed through physical mechanisms between iodine and compound or compounds with large molecular size and structures that can trap molecular iodine. One example is iodine-starch complex, in which iodine is trapped inside the helix of starch molecules.

As used herein, the term “pesticide” is as defined as any substance or mixture of substances intended for protecting plant or plant parts by preventing, destroying, repelling or mitigating any pest, which includes insect pests, pathogenic fungi, pathogenic nematodes, pathogenic bacteria, pathogenic viruses.

As used herein, the term “disinfectant” is as defined as any substance or mixture of substances intended for protecting human being, animals, food or food products, and living or working environment by preventing, destroying, repelling or mitigating any pest, which includes insect pests, pathogenic fungi, pathogenic nematodes, pathogenic bacteria, pathogenic viruses.

1. Iodized Lipid Compositions and their Applications

Preparation of iodized lipids such as iodized oil is well known to those skilled in the art and is described in Merck Index. In accordance with the present invention, iodized lipids were prepared, in general, by adding solutions of molecular iodine or iodine containing compounds or complexes to lipid solution (when such lipids like fatty acid slats are water soluble) or lipid or lipid emulsion (when such lipids are not water soluble). The ratio of iodine to lipids was determined by the iodine value of the lipids. In general, molar of iodine was equal to the molar of double bound in the lipids. Lipid emulsion was prepared by mixing lipids, surfactants such as monolipids or Tween 60, and water at elevated temperatures. For iodine in crystal form such as iodine, aqueous solution was first prepared by adding iodide to potassium iodide or sodium chloride. If desired, the iodized lipids can be processed into dust powder or granules by adding inert such as starch or clays.

According to the present invention, lipids used for manufacturing iodized lipids comprise 1) fatty acids, their salts, esters, or derivatives; 2) fatty alcohols and their derivatives; 3) mono-, di-, and tri-acylglycerides (including phospholipids, glycolipids, and plant or animal oils) and their derivatives; 4) mono-, di-, tri-, and tetra-terpenes, steroids, cholesterols, and their derivatives; and 5) waxes or esters of long chain fatty acids and long chain alcohols and their derivatives.

According to the present invention, iodine used for manufacturing iodized lipids comprises any compounds or mixtures that contain or release iodine, such as molecular iodine; potassium, sodium, calcium, ammonium or lithium iodide; potassium, sodium, calcium, ammonium or lithium iodate; iodic acid; hydroiodic acid; iodine monobromide, iodine monochloride, iodine pentoxide, iodine trichloride; or different commercial iodophors.

In accordance with the present invention, the composition may further contain one or more surfactants, emulsifying, wetting, or dispersing agents. The surfactants include any type of siloxane, polysiloxane, and ionic or non-ionic surfactants. Examples of such surfactants are: lauryl sulfate or lauryl sulfate salts; polyether-polymethylsiloxane-copolymer (Break-Thru. RTM. OE44.1), manufactured by Goldschmidt Chemical Corporation; polyoxyethylenesorbitan, presently sold as the product family TWEEN and marketed by ICI Americas, Inc., of Wilmington, Del.; polyoxyethylene ethers, such as t-octylphenoxy-polyethanol, presently sold as the product family TRITON and marketed by Union Carbide Chemical and Plastics Co., Inc., of Danbury, Conn.; or alkylaryl polyoxyethylene glycols and alcohol, presently sold as Latron AG-98. Alternative surfactants with equivalent action to these typical products are also considered for use with the emulsion compound of the present invention. Other suitable agents include quaternary ammonium compounds such as cetyltrimethyl ammonium bromide, fatty acid soaps; mono- or di-glycerides, phospholipids, glycolipids, glycerine soaps, salts of aliphatic monoesters of sulphuric acid such as sodium lauryl sulphate, salts of sulphonated aromatic compounds like sodium dodecylbenzenesulphonate; sodium, calcium or ammonium lignosulphonate; or butylnaphthalene sulphonate; and a mixture of the sodium salts of diisopropyl- and triisopropylnaphthalenesu-lphonates, condensation products of ethylene oxide with fatty alcohols such as oleyl alcohol or cetyl alcohol; or with alkyl phenols such as octyl phenol, nonyl phenol, and octyl cresol, partial esters derived from long chain fatty acids and hexitol anhydrides, the condensation products of the said partial esters with ethylene oxide, mineral oils, and short chain fatty acid or organic acids such as formic acid, acetic acid, propionic acid, butyric acid, valeric acid, caproic acid, enanthic acid, caprylic acid, pelargonic acid, capric acid, undecanoic acid, pauric acid, oxalic acid, manolic acid, succinic acid, glutaric acid, adipic acid, pimelic acid, suberic acid, azelaic acid, sebacic acid, brassylic acid, thapsic acid, maleic acid, fumaric acid, glutaconic acid, malic acid, tartaric acid, citric acid.

According to the present invention, the composition may be formulated into aqueous solution, emulsion, or dust powders or granules by using inert. The inert can be used includes kaolinite minerals such as kaolinite, dickite, nacrite, and haloysite, serpentines such as chrysotile, lizartite, antigorite, and amesite, smectites such as calcium montmorillonite, magnesium montmorillonite, saponite, hectorite, sauconite, and beidellite, magnesium silicates such as attapulgite and sepiolite, calcium carbonates such as dolomite; sulfate minerals such as gypsum and terra alba, mica clay minerals such as muscovite, phengite, sericite, and illite, silicas such as cristobalite and quartz, pyrophyllite, talc, pagodite, acid clay, activated clay, diatomaceous earth, pumice, silica sand, zeolite, vermiculite; synthetic inorganic carriers such as precipitated silicas, and calcined silicas; starch containing materials such as amylose, amylospetcin, starch, modified starch such as acid, alkaline, or enzyme treated starch, oxidized starch, dextrin roasted starch, or esterified starch, starch containing flours from plant sources, degradation products from flours or starch, dextrin, woodmeal, rice bran, wheat bran, husks of grains, soybean meal; lignin containing compounds such as lignin or lignin sulfonate, algae derived materials such as alginic acid and alkali metal salts of alginic acid such as sodium alginate and potassium alginate and ammonium salts of alginic acid, calcium alginate, magnesium alginate, barium alginate, zinc alginate, nickel alginate, copper alginate, lead alginate, strontium alginate, cobalt alginate, or manganese alginate; chromatographic matrix materials such as arga, argarose, cellulose, polyvinyl alcohol, polyvinyl acetal, polyacrylamide, methacrylate, polyethylene, polypropylene, polystyrene, or their derivatives.

In accordance with the present invention, the composition contains from 0.001%-99% iodized lipids, preferably from 0.01% to 80% iodized lipids and most preferably from 20% to 60% iodized lipids.

In accordance with the present invention, the composition contains from 0.00001%-50% iodine, preferably from 0.0001% to 20% iodine and most preferably from 0.001% to 5% iodine.

The composition of the present invention are dispersed or dissolved in water to a concentration of from 0.00001% to 20% iodized lipids, preferably from 0.0001% to 10% iodized lipids and most preferably from 0.001% to 5% iodized lipids. The diluted compositions may be applied by any of the methods typically known and used in the agricultural industry, food industry, or dairy farms for the application of a chemical.

2. Type II Iodine Complexes and their Applications

Preparation of type II iodine complex such as iodine-starch index is well known to the person of the art and is described in U.S. Pat. No. 5,955,101. In accordance with the present invention, the type II iodine complexes in the present invention can be generally prepared by the following method: Iodine solution was made by dissolving 5 g sodium chloride, 2 g sodium iodate, and 10 g iodine in 80 mL of ethanol. Then 73 gram of complexing compounds is mixed with the iodine solution and the mixture is dried at room temperature and grinded in a ball-mill for at least 4 hours to produce dry iodine complex dust powder. If desired, the dust powder can be processed into granules or suspended in aqueous solution by adding wetting agents.

According to the present invention, type II iodine complexes are manufactured using polymers and iodine or iodine containing or releasing compounds or complexes. The iodine comprises any compounds or mixtures that contain or release iodine, such as molecular iodine; potassium, sodium, calcium, ammonium or lithium iodide; potassium, sodium, calcium, ammonium or lithium iodate; iodic acid; hydroiodic acid; iodine monobromide, iodine monochloride, iodine pentoxide, iodine trichloride; or different commercial iodophors.

In accordance with the present invention, the polymers for forming iodine complexes include amylose, starch and amylose or starch containing materials such as amylose, amylospetcin, starch, modified starch such as acid, alkaline, or enzyme treated starch, oxidized starch, dextrin roasted starch, or esterified starch, starch containing flours from any plant sources, degradation products from flours or starch, dextrin or their derivatives.

In accordance with the present invention, the composition may be formulated into aqueous solution, emulsion, or dust powders or granules by using inert. The inert can be used includes cellulose or cellulose containing materials such as wood meal, rice bran, wheat bran, or husks of grains; lignin or lignin containing materials such as lignin sulfonate; materials derived from algae such as alginic acid, alkali metal salts of alginic acid like sodium alginate and potassium alginate and ammonium salts of alginic acid, calcium alginate, magnesium alginate, barium alginate, zinc alginate, nickel alginate, copper alginate, lead alginate, strontium alginate, cobalt alginate, or manganese alginate; and chromatographic matrix materials such as arga, argarose, cellulose, polyvinyl alcohol, polyvinyl acetal, polyacrylamide, methacrylate, polyethylene, polypropylene, polystyrene, or their derivatives.

In accordance with the present invention, the composition contains from 0.001%-100% type II iodine complexes, preferably from 1% to 100% type II iodine complexes and most preferably from 10% to 100% type II iodine complexes.

In accordance with the present invention, the composition contains from 0.00001%-50% iodine, preferably from 0.0001% to 20% iodine and most preferably from 0.001% to 10% iodine.

The composition of the present invention are either directly used or dispersed in water for application. When directly used, its application rates are from 0.001 to 100 pound of complex per acre, preferably 0.1 to 50 pound per acre and most preferably 1 to 20 pound per acre. When used as dispersion, application rates are from 0.0001% to 20% complexes, preferably from 0.001% to 10% complexes and most preferably from 0.01% to 5% complexes. The compositions may be applied by any of the methods typically known and used in the agricultural industry, food industry, or dairy farms for the application of a chemical.

### EXAMPLES

1 Iodized Lipids

In the following tests, iodized lipids (40% lipids, w/v, and 40% total iodine, w/v) were prepared as above described. Iodine solution (40% total iodine, w/v) and lipid (40% w/v) solution from the same iodine lipid formulation were also prepared separately for comparison. At application, one liter of solution was diluted with 99 liters of water and the diluted solution containing 0.4% lipids or 0.4% total iodine.

### Example 1

Against Aphids on Tomato Plants

Adult aphids were collected from heavily infested tomato plants and evenly brushed onto uninfested tomato plants (100 per plants) in the fields. Treatments included lipid, iodine, and iodized lipid formulations as presented in Table 1. Each treatment contained 3 replications and each replication consisted of 3 plants. Aphid infested plants were covered by plastic film individually and left overnight before treatment. Treatments were applied to running off the next day using a hand sprayer. The individual treated and control plant was then covered by colorless plastic film again and mortality was assessed 4 days after treatment. Both lipid and iodine formulations killed certain percentages of aphids, but the iodized lipid formulation was more effective in aphid control.

TABLE 1
Effects of iodine, lipid, or iodized lipid on mortality of aphids

| Treatment | Aphid survival (%) |
|---|---|
| Control | 96 |
| Iodine solution (0.4% total iodine) | 37 |
| Fatty acid salts (0.4%) | 52 |
| Iodized fatty acid salts | 4 |
| (0.4% fatty acid salts + 0.4% total iodine) | |

### Example 2

Against Cutworm Larvae on Bean Plants

Variegated cutworm were reared in the laboratory on artificial diet and transferred to plants in the fields (50 3_{rd} instar larvae per plant). Treatments included lipid, iodine, and iodized lipid formulations as presented in Table 2. Each treatment contained 3 replications and each replication consisted of 3 plants. Larvae infested plants were left overnight and treatments were applied to running off the next day using a hand sprayer. Mortality was assessed 4 days after treatment. Both lipid and iodine formulations caused certain percentages of mortality, but the iodized lipid formulation was the most effective treatment.

TABLE 2
Effects of iodine, lipid, or iodized lipids on
mortality of cutwarm larva

| | Cutwarm larva survival |
|---|---|
| Treatment | (%) |
| Control | 100 |
| Iodine solution (0.4% total iodine) | 34 |
| Fatty acid salts (0.4%) | 42 |
| Iodinated fatty acid salts | 8 |
| (0.4% fatty acid salts + 0.4% total iodine) | |

### Example 3

Against Twospotted Spider Mite on Strawberries

Mite was collected from heavily infested strawberries plants and 50 mites were transferred to each of the tested plants in the fields. Treatments included different lipid, iodine, and iodized lipid formulations as presented in Table 3. Each treatment contained 3 replications and each replication consisted of 3 plants. Mite infested plants were left overnight and treatments were applied to running off the next day using a hand sprayer. Mortality was assessed 24 hours after treatment. Both lipid and iodine formulations caused certain percentages of mortality, but iodized lipid formulation was the most effective treatment.

TABLE 3
Effects of iodine, lipid, or iodized lipid on mortality of spider mite

| Treatment | Mite survival (%) |
|---|---|
| Control | 99 |
| Iodine solution (0.4% total iodine) | 41 |
| Fatty acid salts (0.4%) | 49 |
| Iodinated fatty acid salts | 4 |
| (0.4% fatty acids + 0.4% total iodine) | |

### Example 4

Against Apple Scab and Pear Psylla

Apple orchard with heavy scab disease and pear orchard with heavy psylla infection history were chosen for the tests. Treatments included lipid, iodine, and iodized lipid formulations as presented in Table 4. Each treatment contained 3 replications and each replication consisted of 3 trees with a randomized design. Trees were sprayed with handgun to running off during growing season (from bloom to one month before harvest) for 4 times. Scab and psylla were evaluated one week after each application. Means were of the four evaluations were presented. Both lipid and iodine formulations reduced population of pear psylla. Iodine reduced scab but lipid formulation did not. Iodized lipid formulation was more effective in disease and insect control than lipid or iodine applied alone.

TABLE 4
Effects of iodine, lipid, or iodized lipid on
apple scab and pear psylla

| | Apple scab (% | Psylla (% of |
|---|---|---|
| Treatment | leaves affected) | control) |
| Control | 67 | 100 |
| Iodine solution (0.4% total iodine) | 16 | 59 |
| Fatty acid salts (0.4%) | 62 | 48 |
| Iodinated fatty acid salts | 6 | 12 |
| (0.4% fatty acid salts + 0.4% total iodine) | | |

### Example 5

Against Pwdery Mildew and Botrytis on Grapes

Table grape orchard with heavy powdery mildew and Botrytis history was chosen for the tests. Treatments included different lipid, iodine, and iodized lipid formulations as presented in Table 5. Each treatment contained 3 replications and each replication consisted of 10 vines. Vines were sprayed with handgun to running off during growing season (from bloom to one month before harvest) for 4 times. Disease intensity evaluated one week after the last application. Iodine reduced powdery mildew on leaves and Botrytis rot on fruit, but lipid formulations did not. Iodized lipid formulation was more effective in disease control than iodine applied alone.

TABLE 5
Effects of iodine, lipids, or iodized lipids on powdery
mildew and botrytis rot of grapes

| | Powdery mildew | |
|---|---|---|
| Treatment | (% leave affected) | Botrytis rot (%) |
| Control | 34 | 28 |
| Iodine solution (0.4% total iodine) | 11 | 9 |
| Fatty acid salts (0.4%) | 24 | 29 |
| Iodinated fatty acid salts | 3 | 2 |
| (0.4% fatty acids + 0.4% total iodine) | | |

### Example 6

Against Gray Rot on Citrus

Orange orchard with heavy gray mold history was chosen for the tests. Treatments included different lipid, iodine, and iodized lipid formulations as presented in Table 6. Each treatment contained 3 replications and each replication consisted of 3 trees with a randomized design. Trees were sprayed with handgun to running off during growing season (from bloom to one month before harvest) for 4 times. Gray rot of fruit was evaluated one week after each application. Iodine reduced scab and powdery mildew but lipid formulations did not. Iodized lipid formulation was more effective in disease control than lipids or iodine applied alone.

TABLE 6
Effects of iodine, lipid, or iodized lipids on gray rot of orange

| Treatment | Gray rot (%) |
|---|---|
| Control | 31 |
| Iodine solution (0.4% total iodine) | 12 |
| Fatty acid salts (0.4%) | 28 |
| Iodinated fatty acid salts | 6 |
| (0.4% fatty acids + 0.4% total iodine) | |

### Example 7

Against Brown Rot on Peaches

Peach orchard with heavy brown rot history was chosen for the tests. Treatments included different lipid, iodine, and iodized lipid formulations as presented in Table 7. Each treatment contained 3 replications and each replication consisted of 3 trees with a randomized design. Trees were sprayed with handgun to running off during growing season (from bloom to one month before harvest) for 4 times. Brown rot was evaluated one week after each application. Iodine reduced scab and powdery mildew but lipid formulations did not. Iodized lipid formulation was more effective in disease control than iodine applied alone.

TABLE 7
Effects of iodine, lipid, or iodized lipid on brown rot of peaches

| Treatment | Brown rot (%) |
|---|---|
| Control | 21 |
| Iodine solution (0.4% total iodine) | 9 |
| Fatty acid salts (0.4%) | 22 |
| Iodinated fatty acid salts | 4 |
| (0.4% fatty acids + 0.4% total iodine) | |

### Example 8

Against Bacteria and Virus Disease

Tomato fields with history of heavy bacteria or virus diseases were selected and different formulations of iodine, lipid, or iodized lipid were sprayed to tomato plants three times from May to July and disease was evaluated two weeks after the last treatment. Iodine reduced bacteria and virus diseases but lipid formulation did not. Iodized lipid formulation was more effective in disease control than iodine applied alone.

TABLE 8
Effects of iodine, lipid, or iodized lipid on
bacteria and virus disease

| | Bacterial | Verticillium | |
|---|---|---|---|
| Treatment | spot | wilt | TMV I |
| Control | 18 | 27 | 13 |
| Iodine solution (0.4% total iodine) | 9 | 12 | 8 |
| Fatty acid salts (0.4%) | 21 | 25 | 15 |
| Iodinated fatty acid salts | 0 | 2 | 0 |
| (0.4% fatty acids + 0.4% total iodine) | | | |

### Example 9

Against Nematode in Peanut Fields

Peanut fields with nematode history were selected and 3 m×3 m plots were used. Soil treatments were made to individual plot using drip irrigation just prior to planting the certified disease-free transplants with different formulations of iodine, lipid, or iodized lipid, respectively. Another application was made during flowering. 100 liters of solution (0.4%) was applied to each plot. Nematode and yield were evaluated at harvest and presented in Table 9. Iodine reduced nematode population but lipid alone did not. Iodized lipid formulation showed synergistic effects in nematode control and yield increase.

TABLE 9
Effects of iodine, lipids, or iodized lipids on
nematode control and peanut yield.

| | Nematode ) | |
|---|---|---|
| Treatment | (% of control | Yield (% of control) |
| Control | 100 | 100 |
| Iodine solution (0.4% total iodine) | 46 | 124 |
| Fatty acid salts (0.4%) | 100 | 100 |
| Iodinated fatty acid salts | 11 | 138 |
| (0.4% fatty acids + 0.4% total iodine) | | |

### Example 10

Against Storage Decay of Pome and Stone Fruit

“Bartlett’ pears were inoculated with gray and blue mold and ‘Huang Jin’ peaches inoculated with brown rot at harvest. After drying at room temperature for one day, the inoculated fruit were dipped in different formulations of iodine, lipid, or iodized lipid, respectively. Fruit decay was evaluated after keeping at room temperature (20 C) for 2 (peach) or 4 (pear) weeks. Results were presented in Table 10. Iodine reduced fruit decay but lipid formulations did not. Iodized lipid was more effective in decay control than iodine applied alone.

TABLE 10
Effects of iodine, lipids, or iodized lipids on fruit decay

| | Bartlett pear (%) | | ‘Huang Jin’ (%) |
|---|---|---|---|
| Treatment | Gray mold | Blue mold | Brown rot |
| Control | 100 | 100 | 100 |
| Iodine solution (0.4% total | 29 | 38 | 46 |
| iodine | | | |
| Fatty acid salts (0.4%) | 100 | 100 | 100 |
| Iodinated fatty acid salts | 5 | 13 | 14 |
| (0.4% fatty acids + 0.4% total | | | |
| iodine) | | | |

### Example 11

Against Bacteria for Mastitis Control

200 cows with various degree of mastitis disease were randomly divided into two groups and were treated with iodinated lipids and a commercial iodophor, respectively. The treatments included teat and bedding surrounding treatment, which was applied once a week for 6 weeks and effects were evaluated 10 days after the last treatment. Both commercial iodophor and iodized lipids controlled mastitis to very low level. However, iodized lipid treatment resulted fewer teat cracks, scores, and callousing compared with commercial iodophor treatment.

### Example 12

Iodine Release after Aapplication

Iodine solution and an iodinated lipid solution containing the same amount of total iodine were sprayed, respectively, to cotton leaves in the field. Total iodine and molecular iodine were measured at application, 12, 24, 36, and 48 hours after application. The leaves were obtained from the fields, weighted, washed with acetone, and the washing solution was used for total iodine and molecular iodine measurement. When applied as iodine solution, molecular iodine concentration was high at day one but decreased to zero at day 2. lodinated lipid, however, released molecular iodine constantly for 4 days and had relatively high concentration at day 4.

TABLE 12
Total iodine and molecular iodine (ug/g leave) on cotton
leave after application in field conditions

| | Iodized lipid (0.4% lipid | | | |
|---|---|---|---|---|
| | 0.4% iodine) | | | |
| Hours after | Total | Molecular | Iodine solution (0.4% iodine) | |
| application | iodine | iodine | Total iodine | Molecular iodine |
| 0 | 82 | 18 | 78 | 45 |
| 12 | 47 | 21 | 32 | 11 |
| 24 | 39 | 14 | 6 | 1 |
| 36 | 34 | 16 | 0 | 0 |
| 48 | 28 | 14 | 0 | 0 |

2 Type II Iodine Complexes

In the following tests, iodine complexes were prepared according to formulation 1 (10% total iodine, w/v). A separate solution containing 10% total iodine prepared by dissolving molecular iodine in sodium iodide solution was used for comparison. At application, one liter iodine solution or iodine complex composition was diluted with 999 liters of water (final iodine 0.01% or 100 ppm). All compositions were spayed with handgun until runoff.

### Example 13

Against Aphids on Tomato Plants

Adult aphids were collected from heavily infested tomato plants and evenly brushed onto uninfested tomato plants (100 per plants) in the fields. Each treatment contained 3 replications and each replication consisted of 3 plants. Aphid infested plants were covered by plastic film individually and left overnight before treatment. Treatments were applied to running off the next day using a hand sprayer. The individual treated and control plant was then covered by colorless plastic film again and mortality was assessed 4 days after treatment. Iodine at 0.01% was less effective than iodine complex in aphid control (Table 1).

TABLE 13
Effects of iodine and iodine complex on mortality of aphids

| Treatment | Aphid survival (%) |
|---|---|
| Control | 100 |
| Iodine solution (0.01% iodine) | 57 |
| Iodine complex 1 (0.01% iodine) | 11 |

### Example 14

Against Cutworm Larvae on Bean Plants

Variegated cutworm were reared in the laboratory on artificial diet and transferred to plants in the fields (50 3^{rd} instar larvae per plant). Each treatment contained 3 replications and each replication consisted of 3 plants. Larvae infested plants were left overnight and treatments were applied to running off the next day using a hand sprayer. Mortality was assessed 4 days after treatment. Iodine alone was less effective than iodine complex in controlling cutwarm larva (Table 2).

TABLE 14
Effects of iodine and iodine complex on mortality of cutwarm larva

| | Cutwarm larva survival |
|---|---|
| Treatment | (%) |
| Control | 100 |
| Iodine solution (0.01% iodine) | 89 |
| Iodine complex 1 (0.01% iodine) | 12 |

### Example 15

Against Twospotted Spider Mite on Strawberries

Mite was collected from heavily infested strawberries plants and 50 mites were transferred to each of the tested plants in the fields. Each treatment contained 3 replications and each replication consisted of 3 plants. Mite infested plants were left overnight and treatments were applied to running off the next day using a hand sprayer. Mortality was assessed 24 hours after treatment. Iodine alone was less effective than iodine complex in mite control (Table 3).

TABLE 15
Effects of iodine and iodine complex on mortality of spider mite

| Treatment | Mite survival (%) |
|---|---|
| Control | 100 |
| Iodine solution (0.01% iodine) | 54 |
| Iodine complex 1 (0.01% iodine) | 8 |

### Example 16

Against Apple Scab “Golden Delicious’ apple orchard with heavy scab disease infection history was chosen for the tests. Each treatment contained 3 replications and each replication consisted of 3 trees with a randomized design. Trees were sprayed with handgun to running off during growing season (from bloom to one month before harvest) for 4 times according to scab infection periods. Incidence of scab on leaves of terminal shoots was evaluated after fruit harvest. Iodine alone reduced severity of apple scab. Iodine complex were more effective in disease control than iodine applied alone (Table 4).

TABLE 16
Effects of iodine and iodine complex on apple scab

| | Apple scab | Fruit russet |
|---|---|---|
| Treatment | (% leaves affected) | (%) |
| Control | 34.8 | 7 |
| Iodine solution (0.01% iodine) | 11.1 | 5 |
| Iodine complex 1 (0.01% iodine) | 1.5 | 7 |

### Example 17

Against Powdery Mildew on Cherries

Sweet cherries ‘Red Lantern” orchard with heavy powdery mildew history was chosen for the tests. Each treatment contained 3 replications and each replication consisted of 5 trees. Trees were sprayed with handgun to running off during growing season (from bloom to one month before harvest) for 4 times from first mildew symptom with a 2 weeks interval. Disease intensity (per cent affected leaf area) and fruit skin damage were evaluated at harvest. Iodine reduced powdery mildew on leaves but was less effective than the iodine complex (Table 5).

TABLE 17
Effects of iodine and iodine complex on powdery
mildew and botrytis rot of cherries

| | Powdery mildew | Fruit skin damage |
|---|---|---|
| Treatment | (% leave affected) | (%) |
| Control | 24 | 0 |
| Iodine solution (0.01% iodine) | 15 | 0 |
| Iodine complex 1 (0.01% iodine) | 3.4 | 0 |

### Example 18

Against Gay Rot on Citrus

Orange orchard with heavy gray mold history was chosen for the tests. Each treatment contained 3 replications and each replication consisted of 3 trees with a randomized design. Trees were sprayed with handgun to running off during growing season (from bloom to one month before harvest) for 4 times. Gray rot of fruit was evaluated at harvest. Iodine reduced gray rot but was not as effective as the iodine complex composition (Table 6).

TABLE18
Effects of iodine complex on gray rot of orange

| Treatment | Gray rot (%) |
|---|---|
| Control | 32 |
| Iodine solution (0.01% iodine) | 19 |
| Iodine complex 1 (0.01% iodine) | 5 |

### Example 19

Against Brown Rot on Peaches

Peach orchard with heavy brown rot history was chosen for the tests. Each treatment contained 3 replications and each replication consisted of 3 trees with a randomized design. Trees were sprayed with handgun to running off during growing season (from bloom to one month before harvest) for 4 times. Brown rot was evaluated one week after each application. Iodine reduced scab and powdery mildew. Iodine complex was more effective in disease control than iodine applied alone.

TABLE 19
Effects of iodine and iodine complexes on brown rot of peaches

| | Brown rot | Leaf drop |
|---|---|---|
| Treatment | (%) | (%) |
| Control | 24 | 4 |
| Iodine solution (0.01% iodine) | 15 | 6 |
| Iodine complex 1 (0.01% iodine) | 3 | 3 |

### Example 20

Against Bacteria and Virus Disease

Tomato fields with history of heavy bacteria or virus diseases were selected and different treatments were applied to tomato plants three times from May to July and disease was evaluated one week after the last treatment. Iodine alone reduced diseases but was less effective than iodine complex in disease control (Table 8).

TABLE 20
Effects of iodine and iodine complexes
on bacteria and virus disease

| | Bacterial | | |
|---|---|---|---|
| Treatment | spot | Verticillium wilt | TMV I |
| Control | 29 | 20 | 22 |
| Iodine solution (0.01% iodine) | 17 | 11 | 11 |
| Iodine complex 1 (0.01% iodine) | 7 | 4 | 5 |

### Example 21

Against Nematode in Peanut Fields

Peanut fields with nematode history were selected and 3 m×3 m plots were used. Soil treatments were made by adding iodine complex granules (10 g/plot) to individual plot just prior to planting the certified disease-free transplants. Another application with the same rate was made after the first flower. Nematode and yield were evaluated at harvest and presented in Table 9. Iodine complex was effective in nematode control and yield increase.

TABLE 21
Effects of iodine complex granules on nematode
control and peanut yield.

| Treatment | Nematode (% of control) | Yield (% of control) |
|---|---|---|
| Control | 100 | 100 |
| Iodine complex granules | 2.4 | 137 |

### Example 22

Against Storage Decay of Pome and Stone Fruit

“Bartlett’ pears were inoculated with gray and blue mold and ‘Huang Jin’ peaches inoculated with brown rot at harvest. After drying at room temperature for one day, the inoculated fruit were dipped in iodine or iodine complex, respectively. Fruit decay was evaluated after keeping at room temperature (20 C) for 2 (peach) or 4 (pear) weeks. Results were presented in Table 10.

TABLE 22
Effects of iodine and iodine complex on fruit decay

| | Bartlett pear (%) | | ‘Huang Jin’ (%) |
|---|---|---|---|
| Treatment | Gray mold | Blue mold | Brown rot |
| Control | 87 | 94 | 79 |
| Iodine solution (0.01% iodine) | 42 | 35 | 36 |
| Iodine complex 1 | 11 | 8 | 10 |
| (0.01% iodine) | | | |

### Example 23

Against Food Born Diseases

Iodine solution or type II iodine complexes containing 10 ppm total iodine were added to cultures of two test organisms, Escherichia Coli and Micrococcus pyogenes, var. aureus, respectively. After 15, 30, and 60 second, the available iodine was neutralized with sodium thiosulphate. The organisms were then plated and incubated at 35 C for 48 h and the cultures were counted.

TABLE 23
Effects of iodine and iodine complex against food born disease

| | | | |
|---|---|---|---|
| Treatment | 15 sec. | 30 sec | 60 sec |

E. Coli (count/mL)

| | | | |
|---|---|---|---|
| Control | 70,000,000 | 70,000,000 | 70,000,000 |
| Iodine (10 ppm) | 10,289,000 | 135,000 | 0 |
| Iodine complex | 11,000,000 | 523,000 | 0 |
| (10 ppm iodine) | | | |

M. Pyogenes (count/mL)

| | | | |
|---|---|---|---|
| Control | 70,000,000 | 70,000,000 | 70,000,000 |
| Iodine (10 ppm) | 9,289,000 | 25,000 | 0 |
| Iodine complex | 8,000,000 | 23,000 | 0 |
| (10 ppm iodine) | | | |

In compliance with the statutes, the invention has been described in language more or less specific to structural features and process steps. While this invention is susceptible to embodiment in different forms, the specification illustrates preferred embodiments of the invention with the understanding that the present disclosure is to be considered an exemplification of the principles of the invention, and the disclosure is not intended to limit the invention to the particular embodiments described. Those with ordinary skill in the art will appreciate that other embodiments and variations of the invention are possible, which employ the same inventive concepts as described above.

### REFFERENCE ITED

| | | | |
|---|---|---|---|
| U.S. Patent Documents | | | |
| 608,627 | | Thiel | 424/667 |
| 2,739,992 | March 1956 | Shelanski | 524/548 |
| 2,742,736 | | MacKay | |
| 2,931,777 | Apr., 1960 | Shelanski | 252/106 |
| 5,002,763 | Mar., 1991 | Login et al. | 424/80 |
| 5,368,868 | Nov., 1994 | Winicov | 424/667 |
| 5,462,714 | October 1995 | Talwalker et al. | 422/37 |
| 5,916,581 | June, 1999 | Foret et al. | 424/405 |
| 5,955,101 | September 1999 | Ghent and Eskin | 424/451 |
| 20010036482 | November 2001 | Fredell et al. | 424/667 |
| 20010019728 | September 2001 | Basinger et al. | 424/667 |
| International Patent | | | |
| Documents | | | |
| JP 61,183,202 | | | |

We claim:

1. A method for controlling insect pests, diseases, and parasitic nematodes comprising the step of concurrent administration to the locus in need of said treatment of an effective amount of iodized lipids or iodine complexes.

2. The method of claim 1, wherein the insect pests are soft-bodied pests such as aphids, mites, cutwarm, and pear psyla.

3. The method of claim 1, wherein the diseases are caused by fungus, bacteria, or virus.

4. The method of claim 3, wherein the fungus is powdery mildew, botrytis, gray mold, blue mold, and brown rot.

5. The method of claim 3, wherein the bacteria are bacteria spot, E. Coli.

6. The method of claim 3, wherein the virus is Verticillium wilt and TMV.

7. The method of claim 1, wherein the parasitic nematode is root knot nematode.

8. The method of claim 1, wherein the locus in need of treatment is soil, water, seeds, fruits, plants, plant parts, human, animal, diary farm, food facility, or equipment.

9. The method of claim 1, wherein the iodized lipids are formed between iodine and lipids through covalent bounds.

10 The method of claim 9, wherein the lipids are fatty acids, their salts, esters, or derivatives.

11 The method of claim 9, wherein the lipids are fatty alcohols and their derivatives.

12 The method of claim 9, wherein the lipids are mono-, di-, and tri-acylglycerides including pholipids, glycolipids, and plant or animal oils and their derivatives.

13 The method of claim 9, wherein the lipids are mono-, di-, tri-, and tetra-terpenes, steroids, cholesterols, and their derivatives.

14 The method of claim 9, wherein the lipids are waxes or esters of long chain fatty acids and long chain alcohols and their derivatives.

15. The method of claim 1, wherein the iodine-complexes are formed through physical mechanisms between iodine and one or more complexing materials.

16 The method of claim 15, wherein the complexing material has large molecular size and structure that can trap molecular iodine.

17 The method of claim 15, wherein the complexing materials are amylose, starch, or amylose, starch containing materials or their derivatives.

18 The method of claim 1, wherein said iodized lipids are administrated from 0.0001%-20%, preferably from 0.001% to 10% and most preferably from 0.01% to 5%.

19 The composition of claim 1, wherein said iodine complexes are administrated from 0.00001%-20%, preferably from 0.0001% to 10% and most preferably from 0.001% to 5%.
